(19) United States
(12) Patent Application Publication
(10) Pub. No.: US 2017/0086076 A1
(43) Pub. Date: Mar. 23, 2017

(54) SETTING TRANSMISSION PARAMETERS IN SHARED SPECTRUM

(71) Applicant: QUALCOMM Incorporated, San Diego, CA (US)

(72) Inventors: Ahmed Kamel SADEK, San Diego, CA (US); Nachiappan VALLIAPPAN, San Diego, CA (US)

(21) Appl. No.: 14/859,106

(22) Filed: Sep. 18, 2015

(51) Int. Cl. H04W 16/14; H04W 76/04

(52) U.S. Cl. CPC H04W 16/14; H04W 76/048; H04W 84/12

(57) ABSTRACT

Techniques for setting transmission parameters in shared spectrum and related operations are disclosed. A communication method may include operating in accordance with a primary RAT over an operating channel and in accordance with a DTX communication pattern, the DTX communication pattern defining activated periods and deactivated periods of primary-RAT transmission over the operating channel, monitoring secondary-RAT signaling on a shared channel of the secondary RAT that at least partially overlaps in frequency space with the operating channel of the primary RAT, determining a channel type associated with the shared channel, and setting one or more parameters of the DTX communication pattern based on the channel type associated with the shared channel.

### INTRODUCTION

Aspects of this disclosure relate generally to telecommunications, and more particularly to co-existence between wireless Radio Access Technologies (RATs) and the like.

Wireless communication systems are widely deployed to provide various types of communication content, such as voice, data, multimedia, and so on. Typical wireless communication systems are multiple-access systems capable of supporting communication with multiple users by sharing available system resources (e.g., bandwidth, transmit power, etc.). Examples of such multiple-access systems include Code Division Multiple Access (CDMA) systems, Time Division Multiple Access (TDMA) systems, Frequency Division Multiple Access (FDMA) systems, Orthogonal Frequency Division Multiple Access (OFDMA) systems, and others. These systems are often deployed in conformity with specifications such as Long Term Evolution (LTE) provided by the Third Generation Partnership Project (3GPP), Ultra Mobile Broadband (UMB) and Evolution Data Optimized (EV-DO) provided by the Third Generation Partnership Project 2 (3GPP2), 802.11 provided by the Institute of Electrical and Electronics Engineers (IEEE), etc.

In cellular networks, “macro cell” access points provide connectivity and coverage to a large number of users over a certain geographical area. A macro network deployment is carefully planned, designed, and implemented to offer good coverage over the geographical region. To improve indoor or other specific geographic coverage, such as for residential homes and office buildings, additional “small cell,” typically low-power access points have recently begun to be deployed to supplement conventional macro networks. Small cell access points may also provide incremental capacity growth, richer user experience, and so on.

Recently, small cell LTE operations, for example, have been extended into the unlicensed frequency spectrum such as the Unlicensed National Information Infrastructure (U-NII) band used by Wireless Local Area Network (WLAN) technologies. This extension of small cell LTE operation is designed to increase spectral efficiency and hence capacity of the LTE system. However, it may also encroach on the operations of other Radio Access Technologies (RATs) that typically utilize the same unlicensed bands, most notably IEEE 802.11x WLAN technologies generally referred to as “Wi-Fi.”

### SUMMARY

The following summary is an overview provided solely to aid in the description of various aspects of the disclosure and is provided solely for illustration of the aspects and not limitation thereof.

In one example, a communication apparatus is disclosed. The communication apparatus may include, for example, a first transceiver configured to operate in accordance with a primary Radio Access Technology (RAT) over an operating channel and in accordance with a Discontinuous Transmission (DTX) communication pattern, the DTX communication pattern defining activated periods and deactivated periods of primary-RAT transmission over the operating channel, a second transceiver configured to operate in accordance with a secondary RAT and to monitor secondary-RAT signaling on a shared channel of the secondary RAT that at least partially overlaps in frequency space with the operating channel of the primary RAT, a processor configured to determine a channel type associated with the shared channel, and set one or more parameters of the DTX communication pattern based on the channel type associated with the shared channel, and memory coupled to the processor and configured to store data, instructions, or a combination thereof.

In another example, a communication method is disclosed. The communication method may include, for example, operating in accordance with a primary RAT over an operating channel and in accordance with a DTX communication pattern, the DTX communication pattern defining activated periods and deactivated periods of primary-RAT transmission over the operating channel, monitoring secondary-RAT signaling on a shared channel of the secondary RAT that at least partially overlaps in frequency space with the operating channel of the primary RAT, determining a channel type associated with the shared channel, and setting one or more parameters of the DTX communication pattern based on the channel type associated with the shared channel.

In yet another example, a communication apparatus is disclosed. The communication apparatus may include, for example, means for operating in accordance with a primary RAT over an operating channel and in accordance with a DTX communication pattern, the DTX communication pattern defining activated periods and deactivated periods of primary-RAT transmission over the operating channel, means for monitoring secondary-RAT signaling on a shared channel of the secondary RAT that at least partially overlaps in frequency space with the operating channel of the primary RAT, means for determining a channel type associated with the shared channel, and means for setting one or more parameters of the DTX communication pattern based on the channel type associated with the shared channel.

In yet another example, a non-transitory computer-readable medium comprising at least one instruction for causing a processor to perform operations is disclosed. The non-transitory computer-readable medium comprising at least one instruction for causing processor to perform operations may include, for example, code for operating in accordance with a primary RAT over an operating channel and in accordance with a DTX communication pattern, the DTX communication pattern defining activated periods and deactivated periods of primary-RAT transmission over the operating channel, code for monitoring secondary-RAT signaling on a shared channel of the secondary RAT that at least partially overlaps in frequency space with the operating channel of the primary RAT, code for determining a channel type associated with the shared channel, and code for setting one or more parameters of the DTX communication pattern based on the channel type associated with the shared channel.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communication system including an access point in communication with an access terminal.

FIG. 2 illustrates certain aspects of an example long-term DTX communication scheme.

FIG. 3 is a system-level diagram illustrating contention between RATs on a shared communication medium.

FIG. 4 illustrates an example of a channel structure of a wireless link depicted in FIG. 3.

FIG. 5 is a flow diagram illustrating an example communication method.

FIG. 6 illustrates in more detail an example implementation of certain aspects of the method of FIG. 5.

FIG. 7 illustrates in more detail an example implementation of certain aspects of the method of FIG. 5.

FIG. 8 illustrates an example access point apparatus represented as a series of interrelated functional modules.

### DETAILED DESCRIPTION

The present disclosure relates generally to co-existence techniques for operation on a shared communication medium.

An access point that operates in a shared communication medium may yield a portion of the communication medium to other entities. By using a DTX communication pattern, the access point can share the communication medium with the other entities across the time domain. For example, during an activated period of the DTX communication pattern, the access point may operate in accordance with a primary RAT on the shared communication medium, and during a deactivated period of the DTX communication pattern, the access point may monitor secondary-RAT usage of the shared communication medium by the other entities.

In accordance with some aspects of the present disclosure, the access point may set one or more parameters of the DTX communication pattern based on the monitored usage of the secondary RAT. For example, the access point may be operating on a primary-RAT operating channel that overlaps (at least in part) with a shared channel being used for secondary-RAT operations by another entity. The access point may determine whether the shared channel is a primary channel or a secondary channel within a channel structure of the secondary RAT and set one or more parameters of the DTX communication pattern in response to the determination. If the shared channel is identified as a primary channel within the secondary-RAT channel structure, then the access point may set one or more DTX parameters to values associated with low utilization.

As another example, the access point may determine a position of the shared channel within the channel structure of the secondary RAT and set one or more parameters of the DTX communication pattern in response to the determination. If the shared channel is determined to be relatively proximate to a primary channel within the secondary-RAT channel structure, then the access point may set one or more DTX parameters to values associated with low utilization.

More specific aspects of the disclosure are provided in the following description and related drawings directed to various examples provided for illustration purposes. Alternate aspects may be devised without departing from the scope of the disclosure. Additionally, well-known aspects of the disclosure may not be described in detail or may be omitted so as not to obscure more relevant details.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., Application Specific Integrated Circuits (ASICs)), by program instructions being executed by one or more processors, or by a combination of both. In addition, for each of the aspects described herein, the corresponding form of any such aspect may be implemented as, for example, “logic configured to” perform the described action.

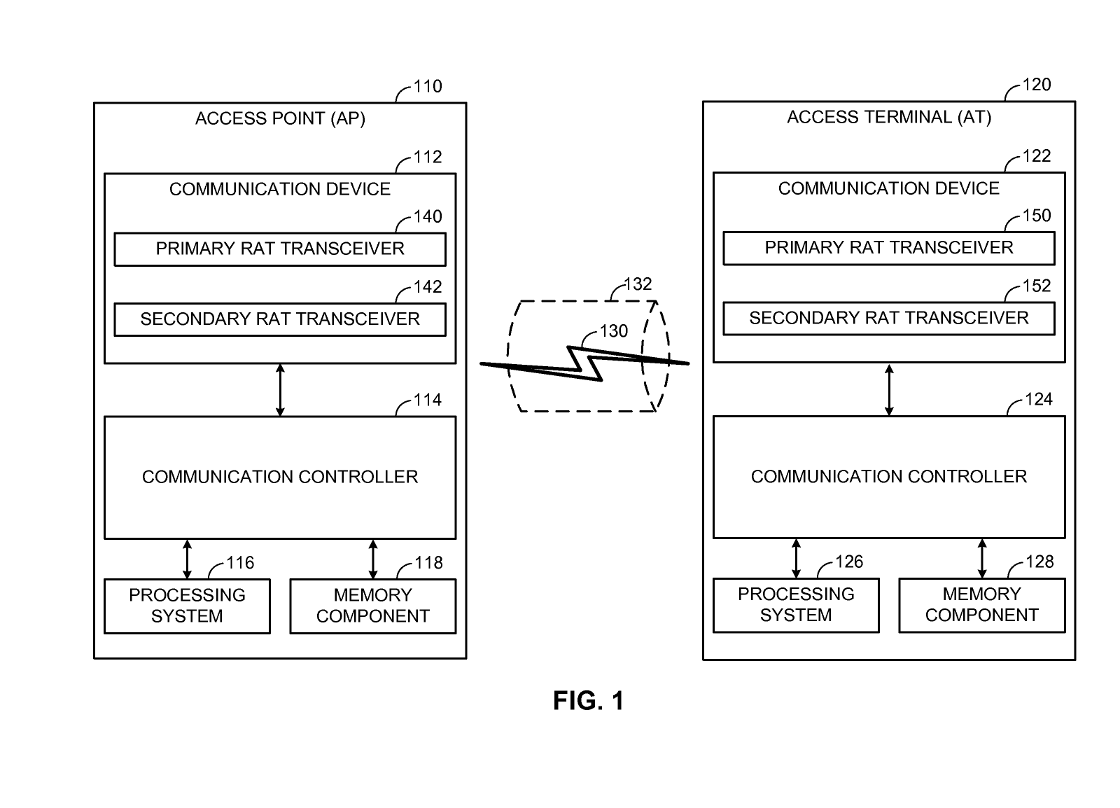

FIG. 1 illustrates an example wireless communication system including an access point in communication with an access terminal Unless otherwise noted, the terms “access terminal” and “access point” are not intended to be specific or limited to any particular Radio Access Technology (RAT). In general, access terminals may be any wireless communication device allowing a user to communicate over a communications network (e.g., a mobile phone, router, personal computer, server, entertainment device, Internet of Things (JOT)/Internet of Everything (JOE) capable device, in-vehicle communication device, etc.), and may be alternatively referred to in different RAT environments as a User Device (UD), a Mobile Station (MS), a Subscriber Station (STA), a User Equipment (UE), etc. Similarly, an access point may operate according to one or several RATs in communicating with access terminals depending on the network in which the access point is deployed, and may be alternatively referred to as a Base Station (BS), a Network Node, a NodeB, an evolved NodeB (eNB), etc. Such an access point may correspond to a small cell access point, for example. “Small cells” generally refer to a class of low-powered access points that may include or be otherwise referred to as femto cells, pico cells, micro cells, Wireless Local Area Network (WLAN) access points, other small coverage area access points, etc. Small cells may be deployed to supplement macro cell coverage, which may cover a few blocks within a neighborhood or several square miles in a rural environment, thereby leading to improved signaling, incremental capacity growth, richer user experience, and so on.

In the example of FIG. 1, the access point 110 and the access terminal 120 each generally include a wireless communication device (represented by the communication devices 112 and 122) for communicating with other network nodes via at least one designated RAT. The communication devices 112 and 122 may be variously configured for transmitting and encoding signals (e.g., messages, indications, information, and so on), and, conversely, for receiving and decoding signals (e.g., messages, indications, information, pilots, and so on) in accordance with the designated RAT. The access point 110 and the access terminal 120 may also each generally include a communication controller (represented by the communication controllers 114 and 124) for controlling operation of their respective communication devices 112 and 122 (e.g., directing, modifying, enabling, disabling, etc.). The communication controllers 114 and 124 may operate at the direction of or otherwise in conjunction with respective host system functionality (illustrated as the processing systems 116 and 126 and the memory components 118 and 128 coupled to the processing systems 116 and 126, respectively, and configured to store data, instructions, or a combination thereof, either as on-board cache memory, separate components, a combination, etc.). In some designs, the communication controllers 114 and 124 may be partly or wholly subsumed by the respective host system functionality.

Turning to the illustrated communication in more detail, the access terminal 120 may transmit and receive messages via a wireless link 130 with the access point 110, the message including information related to various types of communication (e.g., voice, data, multimedia services, associated control signaling, etc.). The wireless link 130 may operate as part of a cell, including Primary Cells (PCells) and Secondary Cells (SCells), on respective component carriers (respective frequencies). The wireless link 130 may operate over a communication medium of interest that includes the component carriers, shown by way of example in FIG. 1 as the communication medium 132, which may be shared with other communications as well as other RATs. A medium of this type may be composed of one or more frequency, time, and/or space communication resources (e.g., encompassing one or more channels across one or more carriers) associated with communication between one or more transmitter/receiver pairs, such as the access point 110 and the access terminal 120 for the communication medium 132.

As an example, the communication medium 132 may correspond to at least a portion of an unlicensed frequency band shared with other RATs. In general, the access point 110 and the access terminal 120 may operate via the wireless link 130 according to one or more RATs depending on the network in which they are deployed. These networks may include, for example, different variants of Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. Although different licensed frequency bands have been reserved for such communications (e.g., by a government entity such as the Federal Communications Commission (FCC) in the United States), certain communication networks, in particular those employing small cell access points, have extended operation into unlicensed frequency bands such as the Unlicensed National Information Infrastructure (U-NII) band used by WLAN technologies, most notably IEEE 802.11x WLAN technologies generally referred to as “Wi-Fi.”

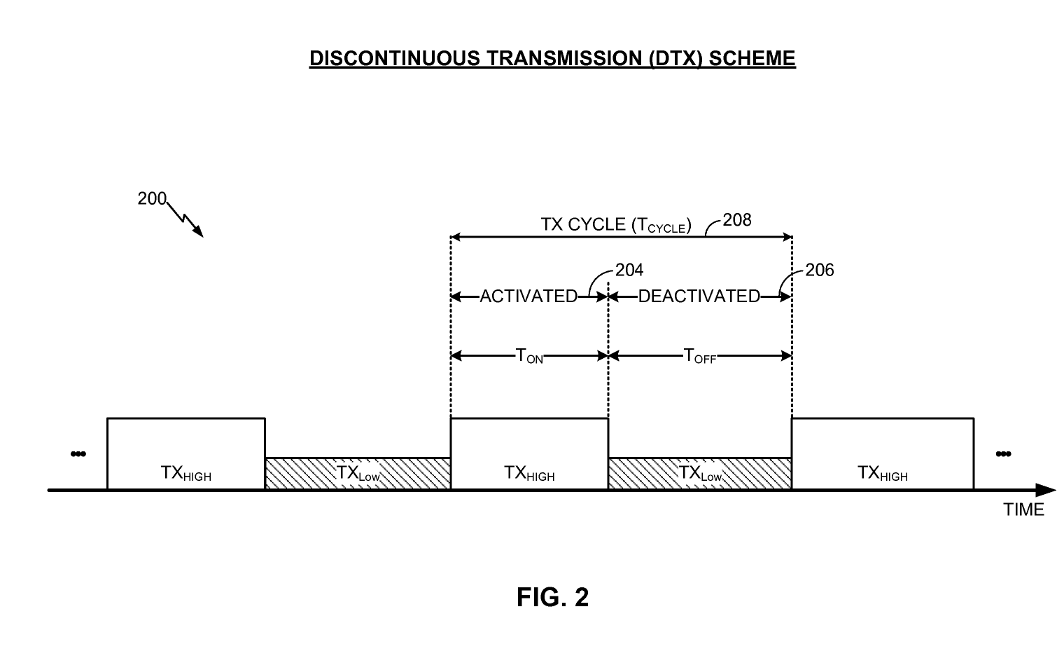

FIG. 2 illustrates certain aspects of an example long-term Discontinuous Transmission (DTX) communication scheme that may be implemented on the communication medium 132. The DTX communication scheme may be used to foster co-existence between (i) primary-RAT communications between the access point 110 and access terminal 120 and (ii) other, secondary-RAT communications between neighboring devices, for example, by switching operation of the primary RAT over the communication medium 132 between activated periods 204 of communication and deactivated periods 206 of communication. A given activated period 204/deactivated period 206 pair may constitute a transmission (TX) cycle (T_{CYCLE}) 208, which collectively form a DTX communication pattern 200. During a period of time T_{ON} associated with each activated period 204, primary RAT transmission on the communication medium 132 may proceed at a normal, relatively high transmission power. During a period of time T_{OFF} associated with each deactivated period 206, however, primary RAT transmission on the communication medium 132 is disabled or at least sufficiently reduced to yield the communication medium 132 to neighboring devices operating according to the secondary RAT. During this time, various network listening functions and associated measurements may be performed by the access point 110, as desired, such as medium utilization measurements, medium utilization sensing, and so on.

In some DTX communication schemes, the switching between activated periods 204 and deactivated periods 206 may be largely predefined (e.g., periodic) and referred to as a Time Division Multiplexing (TDM) communication scheme. A TDM communication scheme may be characterized by a corresponding TDM communication pattern defining the location (timing) of the activated periods 204 and deactivated periods 206 via a set of one or more TDM parameters. Each of the associated TDM parameters, including, for example, a duty cycle (i.e., T_{ON}/T_{CYCLE}) and the respective transmission powers during activated periods 204 and deactivated periods 206, may be adapted based on the current signaling conditions on the communication medium 132 to dynamically optimize the TDM communication scheme. For example, the secondary-RAT transceiver 142 configured to operate in accordance with the secondary RAT (e.g., Wi-Fi) may be further configured to monitor the communication medium 132 during the time period T_{OFF} for secondary-RAT signaling, which may interfere with or be interfered with by primary-RAT communications over the communication medium 132. The access point 110 may be configured to determine a utilization metric associated with utilization of the communication medium 132 by the secondary-RAT signaling. Based on the utilization metric, the associated parameters may be set and the primary-RAT transceiver 140 configured to operate in accordance with the primary RAT (e.g., LTE) may be further configured to cycle between activated periods 204 of communication and deactivated periods 206 of communication over the communication medium 132 in accordance therewith. As an example, if the utilization metric is high (e.g., above a threshold), one or more of the parameters may be adjusted such that usage of the communication medium 132 by the primary-RAT transceiver 140 is reduced (e.g., via a decrease in the duty cycle or transmission power). Conversely, if the utilization metric is low (e.g., below a threshold), one or more of the parameters may be adjusted such that usage of the communication medium 132 by the primary-RAT transceiver 140 is increased (e.g., via an increase in the duty cycle or transmission power).

In other DTX communication schemes, the switching between activated periods 204 and deactivated periods 206 may be conditional and referred to as a Listen Before Talk (LBT) communication scheme. An LBT communication scheme is a contention-based protocol in which the period of time T_{OFF} associated with each deactivated period 206 may be used as a sensing interval for assessment of the communication medium 132 to determine whether to seize it or back off. For example, the secondary-RAT transceiver 142 configured to operate in accordance with the secondary RAT (e.g., Wi-Fi) may be further configured to monitor the communication medium 132 during the time period T_{OFF} for secondary-RAT signaling, and the access point 110 may be configured to determine if other secondary RAT devices are transmitting on the communication medium 132 before initiating the next activated period 204. When no such transmissions are detected (e.g., above a signaling threshold), the next activated period 204 may be initiated. When transmissions are in fact detected, the next activated period 204 may be delayed (e.g., for a backoff period, after which the contention procedure is repeated).

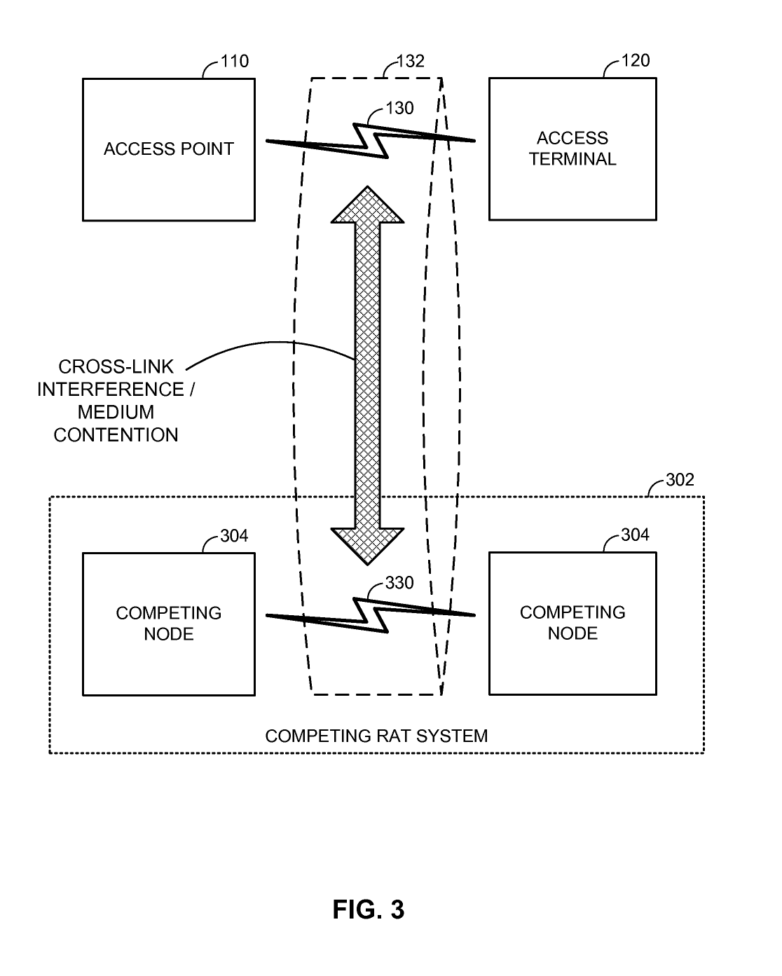

FIG. 3 is a system-level diagram illustrating contention between RATs on a shared communication medium such as the communication medium 132. In this example, the communication medium 132 used for communication between the access point 110 and the access terminal 120 is shared with a competing RAT system 302. The competing RAT system 302 may include one or more competing nodes 304 that communicate with each other over a respective wireless link 330 also on the communication medium 132. As an example, the access point 110 and the access terminal 120 may communicate via the wireless link 130 in accordance with Long Term Evolution (LTE) technology, while the competing RAT system 302 may communicate via the wireless link 330 in accordance with Wi-Fi technology.

As shown, due to the shared use of the communication medium 132, there is the potential for cross-link interference between the wireless link 130 and the wireless link 330. Further, some RATs and some jurisdictions may require contention or “Listen Before Talk (LBT)” for access to the communication medium 132. As an example, the Wi-Fi IEEE 802.11 protocol family of standards provides a Carrier Sense Multiple Access/Collision Avoidance (CSMA/CA) protocol in which each Wi-Fi device verifies via medium sensing the absence of other traffic on a shared medium before seizing (and in some cases reserving) the medium for its own transmissions. As another example, the European Telecommunications Standards Institute (ETSI) mandates contention for all devices regardless of their RAT on certain communication mediums such as unlicensed frequency bands.

Accordingly, it may be necessary in different scenarios for the access point 110 and/or the access terminal 120 to mitigate their interference to and from the competing RAT system 302, as well as to contend for access to the communication medium 132 with the competing RAT system 302.

Returning to the example of FIG. 1, the communication device 112 of the access point 110 includes two co-located transceivers operating according to respective RATs, including a primary-RAT transceiver 140 configured to operate in accordance with one RAT to predominantly communicate with the access terminal 120 and a secondary-RAT transceiver 142 configured to operate in accordance with another RAT to predominantly interact with other RATs sharing the communication medium 132 such as the competing RAT system 302. As used herein, a “transceiver” may include a transmitter circuit, a receiver circuit, or a combination thereof, but need not provide both transmit and receive functionalities in all designs. For example, a low functionality receiver circuit may be employed in some designs to reduce costs when providing full communication is not necessary (e.g., a Wi-Fi chip or similar circuitry simply providing low-level sniffing). Further, as used herein, the term “co-located” (e.g., radios, access points, transceivers, etc.) may refer to one of various arrangements. For example, components that are in the same housing; components that are hosted by the same processor; components that are within a defined distance of one another; and/or components that are connected via an interface (e.g., an Ethernet switch) where the interface meets the latency requirements of any required inter-component communication (e.g., messaging).

The primary-RAT transceiver 140 and the secondary-RAT transceiver 142 may accordingly provide different functionalities and may be used for different purposes. Returning to the LTE and Wi-Fi example above, the primary-RAT transceiver 140 may operate in accordance with LTE technology to provide communication with the access terminal 120 on the wireless link 130, while the secondary-RAT transceiver 142 may operate in accordance with Wi-Fi technology to monitor or control Wi-Fi signaling on the communication medium 132 that may interfere with or be interfered with by the LTE communications. The secondary-RAT transceiver 142 may or may not serve as a full Wi-Fi access point providing communication services to an associated Basic Service Set (BSS). The communication device 122 of the access terminal 120 may, in some designs, include similar primary-RAT transceiver and/or secondary-RAT transceiver functionality, as shown in FIG. 1 by way of the primary-RAT transceiver 150 and the secondary-RAT transceiver 152, although such dual-transceiver functionality may not be required.

As noted above, it may be necessary in different scenarios for the access point 110 and/or the access terminal 120 to mitigate their interference to and from the competing RAT system 302. In an aspect of the disclosure, the access point 110 may operate on the communication medium 132 using the DTX communication pattern 200 of FIG. 2, and may further set one or more parameters of the DTX communication pattern 200 so as to mitigate interference with the competing RAT system 302. For example, the access point 110 may set a duty cycle T_{ON}/T_{CYCLE} of the activated periods 204 of the DTX communication pattern 200, a periodicity T_{CYCLE} of the DTX communication pattern 200, or a combination thereof. As used herein, the term “set” encompasses setting a parameter to a value, resetting a parameter to a value, or modifying a pre-existing setting a parameter to a value.

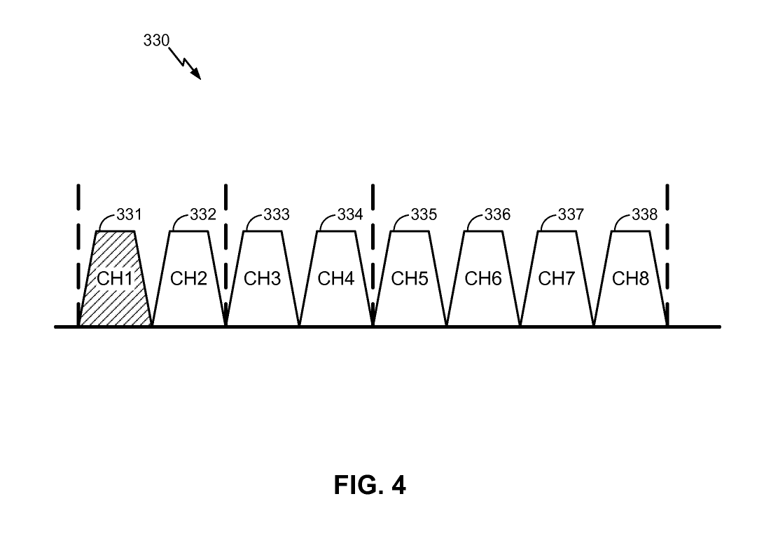

FIG. 4 illustrates an example of a channel structure of the wireless link 330 used by the competing RAT system 302 to communicate within the communication medium 132. In this example, the wireless link 330 comprises eight channels having a total bandwidth of 160 MHz (20 MHz per channel). The eight channels comprise a first channel 331, a second channel 332, a third channel 333, a fourth channel 334, a fifth channel 335, a sixth channel 336, a seventh channel 337, and an eighth channel 338. In some implementations, the wireless link 330 may comprise unlicensed spectrum in the U-NII band and the eight channels 331-338 comprise WLAN channels.

One or more of the nodes 304 may comprise an access point that communicates via one or more of the eight channels 331-338. In this scenario, the node 304 may select a primary channel from among the eight channels 331-338. For example, the first channel 331 may be selected as the primary channel and the remaining channels 332-338 may be secondary channels. In some implementations, the node 304 may broadcast a beacon signal that identifies the first channel 331 as the primary channel. Additionally or alternatively, the beacon signal may identify one or more of the channels 332-338 as one or more secondary channels.

The node 304 may use the primary channel (for example, the first channel 331) to transmit secondary-RAT signaling. However, if additional bandwidth is required for additional secondary-RAT signaling on the wireless link 330, the node 304 may extend operations into one or more of the secondary channels (for example, the channels 332-338). In some implementations, the node 304, upon determining that additional bandwidth is required, extends into an immediately adjacent secondary channel, such that the channels used for secondary-RAT signaling are contiguous. For example, if the node 304 selects the first channel 331 as the primary channel, and then determines that additional bandwidth is required, it will extend operations into a contiguous secondary channel, i.e., second channel 332. If even more additional bandwidth is required, the node 304 will extend operations into the next contiguous secondary channel (the third channel 333), the next contiguous channel (the fourth channel 334), and so on.

In other implementations, the node 304 doubles the number of channels used for communications upon determining that additional bandwidth is required. As noted above, the channels used for communications may be contiguous. For example, if the node 304 selects the first channel 331 as the primary channel, and then determines that additional bandwidth is required, it may extend operations into a contiguous channel (i.e., second channel 332), thereby doubling operations from one channel (the first channel 331) to two channels (i.e., the channels 331-332). If even more additional bandwidth is required, the node 304 will double the number of channels used for secondary-RAT signaling from two channels to four channels (i.e., the channels 331-334). If even more additional bandwidth is required, the node 304 will double the number of channels used for secondary-RAT signaling from four channels to eight channels (i.e., all of the channels 331-338 in the wireless link 330).

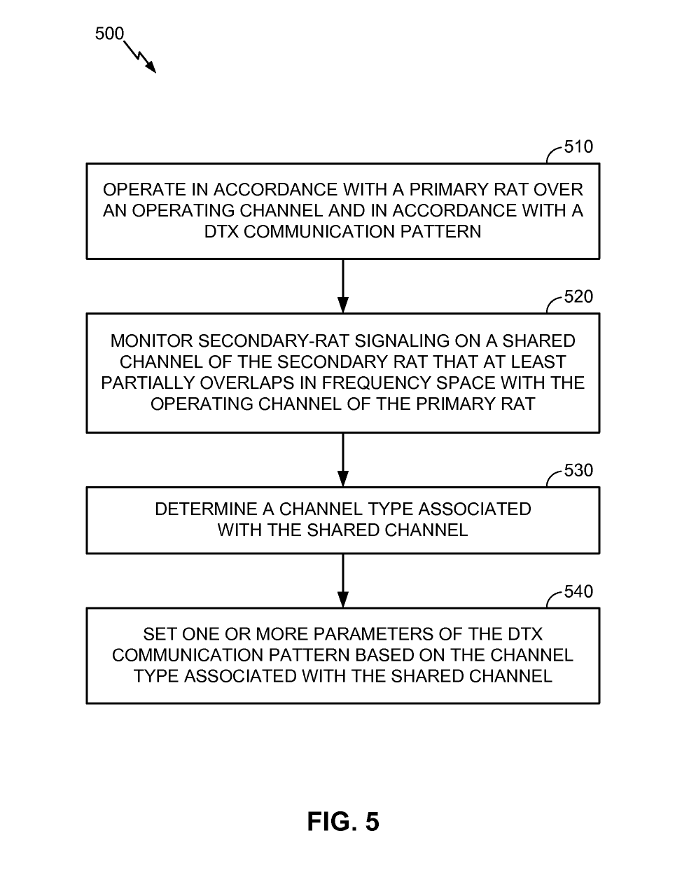

FIG. 5 illustrates a communication method 500 in accordance with an aspect of the disclosure. The communication method 500 may be performed by, for example, one or more components analogous to the primary-RAT transceiver 140, secondary-RAT transceiver 142, communication controller 114, processing system 116, and/or memory component 118 of the access point 110. For the purposes of illustration, the communication method 500 will be described below as it would be performed by the access point 110, however it will be appreciated that other devices and/or a combination of devices may perform the methods described herein.

As shown, the access point 110 may operate in accordance with a primary RAT over an operating channel (such as wireless link 130) and in accordance with a DTX communication pattern (such as DTX communication pattern 200) (block 510). The DTX communication pattern 200 may define activated periods (such as activated periods 204) and deactivated periods (such as deactivated periods 206) of primary-RAT transmission over the operating channel. The operating may be performed, for example, by a transceiver such as the primary-RAT transceiver 140 or the like.

The access point 110 may further monitor secondary-RAT signaling on a shared channel of the secondary RAT (such as wireless link 330) that at least partially overlaps in frequency space with the operating channel of the primary RAT (block 520). The monitoring may be performed, for example, by a transceiver such as the secondary-RAT transceiver 142 or the like.

The access point 110 may further determine a channel type associated with the shared channel (block 530). The determining may be performed, for example, by a processor such as the processing system 116 or the like.

The access point 110 may further set one or more parameters of the DTX communication pattern based on the channel type associated with the shared channel (block 540). The setting may be performed, for example, by a processor such as the processing system 116 or the like.

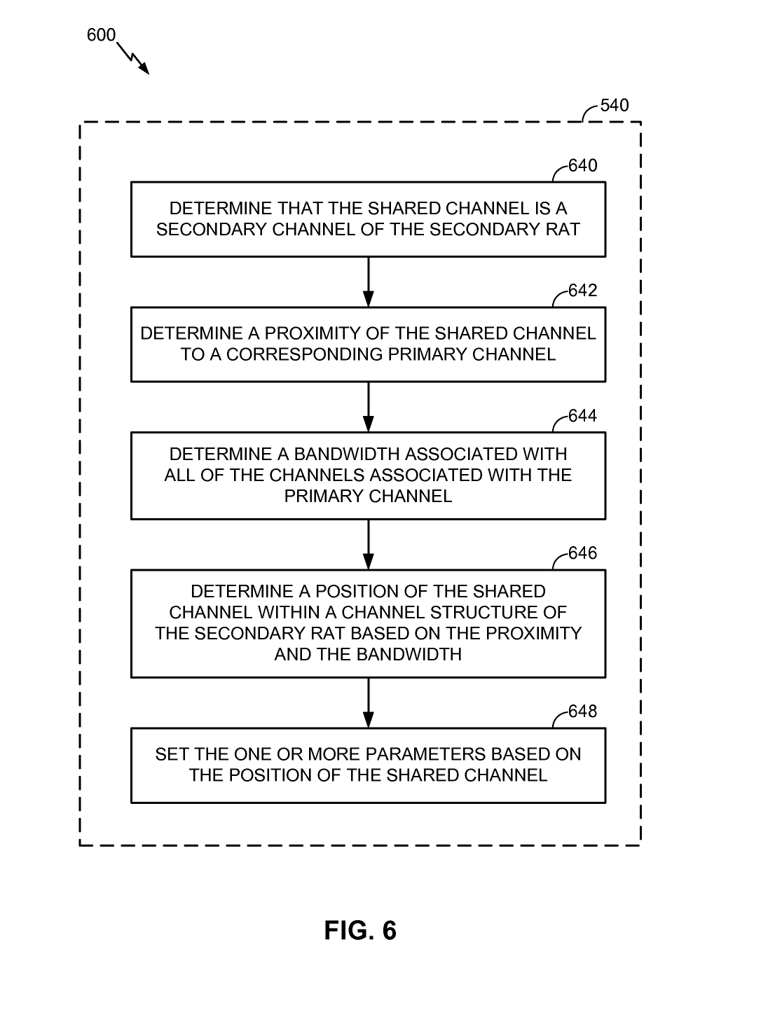

FIG. 6 illustrates in more detail an example implementation of certain aspects of the example method 500 of FIG. 5. In this implementation, more specific operations are shown for the setting at 540. For the purposes of illustration, the method of FIG. 6 will be described below as it would be performed by the access point 110, however, it will be appreciated that other devices may perform the methods described herein.

As noted above in the foregoing description of FIG. 5, the access point 110 may set (at 540) one or more parameters of the DTX communication pattern based on the determination (at 530) of a channel type associated with the shared channel. More specific operations for the setting at 540 (labeled in FIG. 6 as 640, 642, 644, 646, and 648) are described below.

At 640, the access point 110 determines that the shared channel is a secondary channel of the secondary RAT. As noted above, the shared channel may be similar to the wireless link 330 depicted in FIG. 3. The determining at 640 may be performed by, for example, a transceiver such as the secondary-RAT transceiver 142 depicted in FIG. 1. Alternatively or additionally, the determining at 640 may be performed by, for example, a processor such as the processing system 116 depicted in FIG. 1 operating in conjunction with memory such as the memory component 118 depicted in FIG. 1.

In one implementation, the access point 110 determines that the shared channel is a secondary channel of the secondary RAT based on a beacon signal received from a node such as node 304 that is operating on a wireless link 330 in accordance with the secondary RAT. The beacon signal may specifically indicate that the shared channel is a secondary channel for secondary-RAT operations. For example, the access point 110 may receive a beacon signal from the node 304 indicating that the second channel 332 is a secondary channel for secondary-RAT operations of the node 304. Alternatively or additionally, the beacon signal may indicate that a channel other than the shared channel is a primary channel for secondary-RAT operations, and the access point 110 may infer that the shared channel is therefore a secondary channel. For example, the access point 110 may receive a beacon signal from the node 304 indicating that the first channel 331 is a primary channel for secondary-RAT operations of the node 304, and infer that the second channel 332 is therefore a secondary channel.

At 642-646, the access point 110 determines a position of the shared channel within a channel structure of the secondary RAT. As noted above, FIG. 4 depicts an example channel structure having eight channels 331-338. The example channel structure of FIG. 4 may be referred to from time to time in the description that follows, however, it will be understood that the present method may be applied to any channel structure.

At 642, the access point 110 determines a proximity of the shared channel to a corresponding primary channel. The determining at 642 may be performed by, for example, a processor such as the processing system 116 depicted in FIG. 1 operating in conjunction with memory such as the memory component 118 depicted in FIG. 1.

The access point 110 may determine the proximity in terms of, for example, channel proximity or frequency proximity. Returning to an earlier example, consider the scenario in which the shared channel is the second channel 332, and the access point 110 determines that the shared channel is a secondary channel with a corresponding primary channel at first channel 331. The proximity between the second channel 332 and the first channel 331 may be measured as a channel proximity equal to one channel or a frequency proximity equal to 20 MHz.

As another example, consider the scenario in which the shared channel is the seventh channel 337, and the access point 110 determines that the shared channel is a secondary channel with a corresponding primary channel at first channel 331. The proximity between the seventh channel 337 and the first channel 331 may be measured as a channel proximity equal to six channels or a frequency proximity equal to 120 MHz.

At 644, the access point 110 determines a bandwidth associated with all of the channels associated with the primary channel. The determining at 644 may be performed by, for example, a processor such as the processing system 116 depicted in FIG. 1 operating in conjunction with memory such as the memory component 118 depicted in FIG. 1.

The access point 110 may determine the bandwidth in terms of number of channels or band of frequencies. Returning to an earlier example, consider the scenario of FIG. 4 in which the wireless link 330 comprises eight channels having a total bandwidth of 160 MHz (20 MHz per channel). In this scenario, the access point 110 may determine that a bandwidth associated with the channel structure is equal to eight channels, or alternatively, equal to 160 MHz.

At 646, the access point 110 determines a position of the shared channel within a channel structure of the secondary RAT based on the proximity determined at 642 and the bandwidth determined at 644. The determining at 646 may be performed by, for example, a processor such as the processing system 116 depicted in FIG. 1 operating in conjunction with memory such as the memory component 118 depicted in FIG. 1.

The access point 110 may determine the position of the shared channel as a ratio of the proximity determined at 642 to the bandwidth determined at 644. Returning to an earlier example, reconsider the scenario in which the shared channel is the second channel 332. The proximity determined at 642 being one channel (or 20 MHz) and the bandwidth determined at 644 being eight channels (or 160 MHz), the ratio of proximity to bandwidth would be 0.125.

As another example, reconsider the scenario in which the shared channel is the seventh channel 337. The proximity determined at 642 being six channels (or 120 MHz) and the bandwidth determined at 644 being eight channels (or 160 MHz), the ratio of proximity to bandwidth would be 0.750.

At 648, the access point 110 sets one or more parameters based on the position of the shared channel determined at 646. The setting at 648 may be performed by, for example, a processor such as the processing system 116 depicted in FIG. 1 operating in conjunction with memory such as the memory component 118 depicted in FIG. 1.

As an example, the access point 110 may set the one or more parameters to a first set of values for a first position of the shared channel, and set the one or more parameters to a second set of values for a second position of the shared channel, the first position being closer to the primary channel than the second position, and the first set of values being associated with a lower utilization of the operating channel by the first transceiver than the second set of values.

For example, consider a first scenario in which the shared channel is the second channel 332 and a second scenario, presented for the sake of comparison to the first scenario, in which the shared channel is the seventh channel 337. In the first scenario, the position of the shared channel is represented by the ratio 0.125, whereas in the second scenario, the position of the shared channel is represented by the ratio 0.750 (as in the earlier example).

In the first scenario, the access point 110 may set the one or more parameters to a first set of values and in the second scenario, the access point 110 may set the one or more parameters to a second set of values. The position of the shared channel in the first scenario (as represented by the ratio 0.125) is low relative to the position of the shared channel in the second scenario (as represented by the ratio 0.750), indicating that the second channel 332 is closer to the primary channel (first channel 331 in this example) than the seventh channel 337. Accordingly, the first set of values may be associated with a lower utilization of the operating channel than the second set of values. For example, the access point 110 may set one or more parameters of the DTX communication pattern 200 such that it has a decreased duty cycle, a decreased periodicity, or a combination thereof. The primary-RAT transceiver 140 may then operate on the wireless link 130 using the DTX communication pattern 200 set by the access point 110.

As an example, the access point 110 may be configured to set an aggressive DTX communication pattern 200 with a duty cycle (T_{ON}/T_{CYCLE}) of ⅔ or a conservative DTX communication pattern 200 with a duty cycle of ⅓. In one possible implementation, the access point 110 may set the aggressive DTX communication pattern if the position ratio is above 0.500 and a conservative DTX communication pattern if the position ratio is below 0.500. In another possible implementation, the duty cycle can be more finely tuned such that the access point 110 can set a relatively more aggressive DTX communication pattern in response to a relatively higher position ratio or a more conservative DTX communication pattern in response to a relatively lower position ratio. In yet another possible implementation, the duty cycle is set high or low (or adjusted upward or downward) in proportion to the position of the shared channel.

The proximity determined at 642 and the bandwidth determined at 644 may be determined in an alternative manner. Returning to FIG. 4, consider the implementation in which the node 304 doubles the number of channels used for communications when additional bandwidth is required, rather than simply incrementing by one channel. In this scenario, an alternative process for determining proximity at 642 and bandwidth at 644 may yield better results. However, the alternative process need not be implemented in response to a specific determination that the node 304 doubles the number of channels used for communications when additional bandwidth is required, rather than simply incrementing by one channel.

As will be described in greater detail below, the proximity determined at 642 may be calculated as a number of doublings required in order to extend operations to the shared channel. Moreover, the bandwidth determined at 644 may be calculated as a number of doublings required to extend the secondary-RAT operations of the node 304 to the full channel structure.

Returning to an earlier example, consider the scenario in which the shared channel is the second channel 332. In order to extend secondary-RAT operations to the second channel 332 from the first channel 331, the node 304 would need to double the number of channels one time. Accordingly, if the proximity is determined as a number of doublings, then the proximity between the second channel 332 and the first channel 331 may be calculated as one.

As another example, consider the scenario in which the shared channel is the seventh channel 337. In order to extend secondary-RAT operations to the seventh channel 337 from the first channel 331, the node 304 would need to double the number of channels more than one time. By doubling once, the node 304 would only extend secondary-RAT operations to the second channel 332, and by doubling twice, the node 304 would only extend secondary-RAT operations to the second channel 332. Only by doubling three times would the node 304 succeed in extending secondary-RAT operations to the seventh channel 337. Accordingly, if the proximity is determined as a number of doublings, then the proximity between the seventh channel 337 and the first channel 331 may be calculated as three.

It will be appreciated that if proximity is determined in terms of the number of doublings required for the node 304 to extend secondary-RAT operations to the shared channel, then a plurality of different channels within the channel structure may have equal proximities. For example, the node 304 must double its secondary-RAT operations twice to reach the third channel 333. But, by doubling twice, the node 304 extends its operations to the fourth channel 334 as well. Accordingly, the proximity of the third channel 333 will be equal to the proximity of the fourth channel 334. By the same logic, the proximity of the shared channel will be the same (three) regardless of whether the shared channel is the fifth channel 335, sixth channel 336, seventh channel 337, or eighth channel 338.

The bandwidth determined at 644 may also be calculated as a number of doublings required to extend the secondary-RAT operations of the node 304 to the full channel structure. In the channel structure depicted in FIG. 4, the number of doublings required to extend secondary-RAT operations to the entirety of the channel structure is three. Accordingly, the bandwidth determined at 644 may be calculated as three.

Returning to the previous examples, the position of the second channel 332 (calculated in terms of the number of doublings) would be 0.333, and position of the seventh channel 337 (calculated in terms of the number of doublings) would be 1.000.

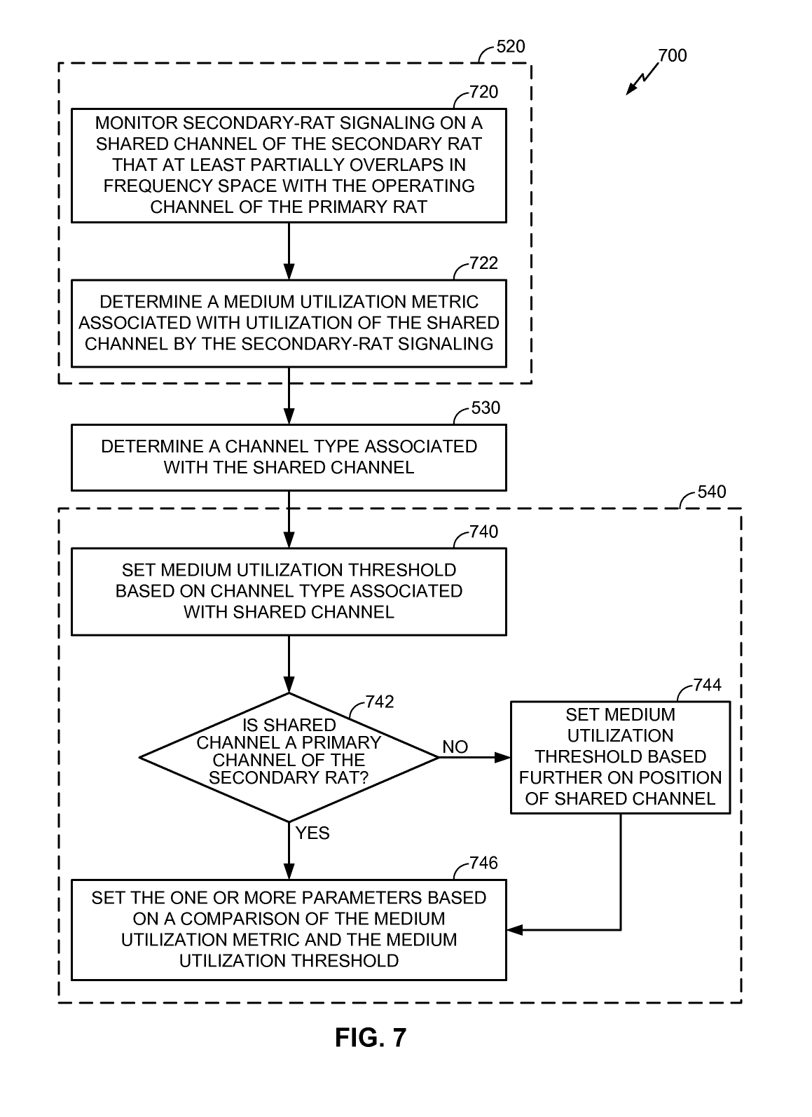

FIG. 7 illustrates in more detail an example implementation of certain aspects of the example method 500 of FIG. 5. In this implementation, more specific operations are shown for the monitoring at 520 and the setting at 540. For the purposes of illustration, the method of FIG. 7 will be described below as it would be performed by the access point 110, however, it will be appreciated that other devices may perform the methods described herein.

As noted above in the foregoing description of FIG. 5, the access point 110 monitors (at 520) secondary-RAT signaling on a shared channel of the secondary RAT that at least partially overlaps in frequency space with the operating channel of the primary RAT. More specific operations for the monitoring at 520 (labeled in FIG. 7 as 720 and 722) are described below.

The operations performed at 720 are identical to the operations performed at 520, in which the access point 110 monitors secondary-RAT signaling on the shared channel, etc. For brevity, a description thereof will not be repeated here.

At 722, the access point 110 determines a medium utilization metric (MUM) associated with utilization of the shared channel by the secondary-RAT signaling. The determining at 722 may be based on the monitoring at 720. The determining at 722 may be performed by, for example, a transceiver such as the secondary-RAT transceiver 142 depicted in FIG. 1. Alternatively or additionally, the determining at 640 may be performed by, for example, a processor such as the processing system 116 depicted in FIG. 1 operating in conjunction with memory such as the memory component 118 depicted in FIG. 1.

In some implementations, the access point 110 may determine the MUM by performing network listening functions. The network listening functions may be performed, for example, during the deactivated period 206 of the DTX communication pattern 200. In an example, the access point 110 transmits primary-RAT signaling over the wireless link 130 during activated periods 204 of the DTX communication pattern 200 and monitors the wireless link 330 for secondary-RAT signaling during deactivated periods 206 of the DTX communication pattern 200.

The medium utilization metric (MUM) may be measured in any suitable manner. In some implementations, medium utilization is measured in terms of an amount of data (for example, a number of packets) communicated on the communication medium 132. In some implementations, medium utilization is measured in terms of received signal strength on the communication medium 132. In some implementations, medium utilization is measured in terms of a number of packets associated with a signal strength above a certain threshold.

As noted above in the foregoing description of FIG. 5, the access point 110 sets at 540 one or more parameters of the DTX communication pattern based on the determination at 530 of a channel type associated with the shared channel. More specific operations for the setting at 540 (labeled in FIG. 7 as 740, 742, 744, and 746) are described below.

At 740, the access point 110 sets a medium utilization threshold (MUT) based on the channel type associated with the shared channel. As noted above, the shared channel may be similar to the wireless link 330 depicted in FIG. 3. The setting at 740 may be performed by, for example, a processor such as the processing system 116 depicted in FIG. 1 operating in conjunction with memory such as the memory component 118 depicted in FIG. 1.

The access point 110 may set the MUT to a first value in response to the channel type indicating that the shared channel is a primary channel of the secondary RAT and set the MUT to a second value in response to the channel type indicating that the shared channel is a secondary channel of the secondary RAT. Moreover, the first value may be associated with a lower utilization of the shared channel than the second value.

As an example, the access point 110 may determine (for example, at 530) that the shared channel is a primary channel used by one of the node 304 to perform secondary-RAT operations on the wireless link 330. As a result, the access point 110 may set a MUT that is low relative to the MUT that would be set if the shared channel was not a primary channel. As will be discussed in greater detail below, a lower MUT may generally lead to lower utilization by the access point 110 of the wireless link 130 for primary-RAT signaling.

At 742, the access point 110 determines if the shared channel is a primary channel of the secondary RAT. The setting at 740 may be performed by, for example, a processor such as the processing system 116 depicted in FIG. 1 operating in conjunction with memory such as the memory component 118 depicted in FIG. 1.

As noted above, the access point 110 determines a channel type associated with the shared channel at 530 and may further set the MUT in accordance with the channel type at 740. The access point 110 may use the channel type determination at 530 to determine at 742 if the shared channel is a primary channel. If the shared channel is not a primary channel (‘NO’ at 742 of FIG. 7), then the example method of FIG. 7 performs additional operations at 744 prior to proceeding to 746. Conversely, if the shared channel is a primary channel (‘YES’ at 742 of FIG. 7), then the example method of FIG. 7 proceeds directly to 746.

At 744, the access point 110 sets the MUT based further on a position of the shared channel within a channel structure of the secondary RAT. The setting at 744 may be performed by, for example, a processor such as the processing system 116 depicted in FIG. 1 operating in conjunction with memory such as the memory component 118 depicted in FIG. 1. The determination of the position of the shared channel may be similar to the processes performed at 642-646, as depicted in FIG. 6, or may be similar to any other position determination set forth in the present disclosure. Accordingly, for the sake of brevity, the details will not be repeated here.

Once the position of the shared channel within a channel structure of the secondary RAT is determined, the access point 110 may set the MUT based on the determined position. As noted above, the access point 110 may have set the MUT based on the channel type (as 740). Accordingly, the setting at 744 may be considered a resetting or modification of the setting performed at 740.

The access point 110 may set a first MUT value in response to a determination that the shared channel has a first position, and may set a second MUT in response to a determination that the shared channel has a second position. Moreover, if the first position is lower than the second position, then the first MUT value may be lower than the second MUT value.

Returning to an earlier example, consider a first scenario in which the shared channel is the second channel 332 and a second scenario, presented for the sake of comparison to the first scenario, in which the shared channel is the seventh channel 337. In the first scenario, the position of the shared channel is represented by the ratio 0.125, whereas in the second scenario, the position of the shared channel is represented by the ratio 0.750 (as noted above).

In the first scenario, the access point 110 may set the MUT to the first MUT value and in the second scenario, the access point 110 may set the MUT to the second MUT value. The position of the shared channel in the first scenario (as represented by the ratio 0.125) is low relative to the position of the shared channel in the second scenario (as represented by the ratio 0.750). Accordingly, the first MUT value may be lower than the second MUT value. As will be discussed in greater detail below, a lower MUT may generally lead to lower utilization by the access point 110 of the wireless link 130 for primary-RAT signaling.

As depicted in FIG. 7, the access point 110 sets the MUT based on both the channel type (as at 740) and based on the position of the shared channel (as at 744). It will be understood, however, that in accordance with the present disclosure, the access point 110 may set the MUT on the basis of the channel type (as at 740) without any consideration as to the position of the shared channel (as at 744). Alternatively, the access point 110 may set the MUT on the basis of the position of the shared channel (as at 744) without any consideration as to the channel type (as at 740).

In yet another aspect of the present disclosure, the determination of the channel type and the determination of the position of the shared channel may be performed as a single determination, wherein a shared channel is determined to have a position of zero if it a primary channel and a non-zero position if it is a secondary channel.

At 746, the access point 110 sets the one or more parameters of the DTX communication pattern 200 based on a comparison of the MUM determined at 722 and the MUT set at 740 and/or 744. The setting at 746 may be performed by, for example, a processor such as the processing system 116 depicted in FIG. 1 operating in conjunction with memory such as the memory component 118 depicted in FIG. 1.

As noted above, a lower MUT may generally lead to lower utilization by the access point 110 of the wireless link 130 for primary-RAT signaling.

Returning to an earlier example, consider a first scenario in which the shared channel is the second channel 332 and a second scenario, presented for the sake of comparison to the first scenario, in which the shared channel is the seventh channel 337. In both scenarios, the shared channel is a secondary channel rather than a primary channel. In the first scenario, the position of the shared channel is represented by the ratio 0.125, whereas in the second scenario, the position of the shared channel is represented by the ratio 0.750 (as noted above).

In the first scenario, a first MUT value is set at 744, reflecting the position ratio of 0.125. In the second scenario, a relatively higher second MUT value is set at 744, reflecting the relatively higher position ratio of 0.750. In one possible implementation, the access point 110 may set a high MUT value if the position ratio is above 0.500 and a low MUT value if the position ratio is below 0.500. In another possible implementation, the duty cycle can be more finely tuned such that the access point 110 can set a relatively high MUT value in response to a relatively higher position ratio or a relatively lower MUT value in response to a relatively lower position ratio. In yet another possible implementation, the MUT value is set high or low (or adjusted upward or downward) in proportion to the position of the shared channel.

Returning to 746, the access point 110 proceeds to compare the MUM (determined at 722) to the MUT (set at 740 and/or 744). In an example, it is assumed that the MUM for the shared channel indicates moderate utilization of the shared channel, for example, 50% utilization. Moreover, it is assumed that in the first scenario (in which the second channel 332 is the shared channel), the first MUT value is set to a value indicating low utilization of the shared channel, for example, 20% utilization (reflecting the position ratio of 0.125). And it is further assumed that in the second scenario (in which the seventh channel 337 is the shared channel), the second MUT value is set to a value indicating high utilization of the shared channel, for example, 80% utilization (reflecting the relatively higher position ratio of 0.750).

In the first scenario, a comparison of the MUM to the MUT indicates that the MUM is greater than the MUT (for example, 50%>20%). Accordingly, the access point 110 may set one or more parameters of the DTX communication pattern 200 to a first set of values. In the second scenario, a comparison of the MUM to the MUT indicates that the MUM is less than the MUT (for example, 50%<80%). Accordingly, the access point 110 may set one or more parameters of the DTX communication pattern 200 to a second set of values. Relative to the first set of values, the second set of values may be associated with higher utilization of the wireless link 130 for primary-RAT signaling.

Although FIGS. 5-7 depict various methods of analysis of a single shared channel, it will be understood that the access point 110 may perform any method of analysis set forth in the present disclosure on any number of shared channels. For example, the access point 110 may analyze each of the eight channels 331-338 depicted in the channel structure of FIG. 4.

Moreover, the access point 110 may use the aforementioned analyses of a plurality of shared channels to perform channels selection. In one possible implementation, the access point 110 may set one or more DTX parameters for each channel in a channel structure. The access point may then select a channel for primary-RAT signaling based on the DTX parameters associated with each channel. For example, the access point 110 may select a channel associated with an aggressive DTX communication pattern 200 rather than a channel associated with a conservative DTX communication pattern 200.

For convenience, the access point 110 and the access terminal 120 are shown in FIG. 1 as including various components that may be configured according to the various examples described herein. It will be appreciated, however, that the illustrated blocks may be implemented in various ways. In some implementations, the components of FIG. 1 may be implemented in one or more circuits such as, for example, one or more processors and/or one or more ASICs (which may include one or more processors). Here, each circuit may use and/or incorporate at least one memory component for storing information or executable code used by the circuit to provide this functionality.

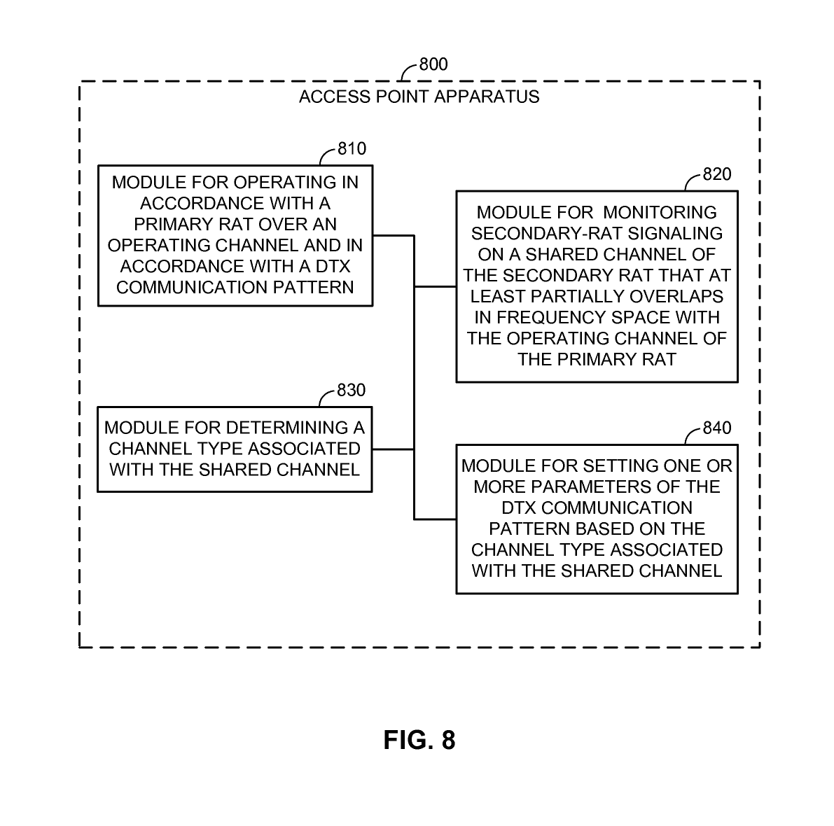

FIG. 8 illustrates an example access point apparatus 800 represented as a series of interrelated functional modules. A module for operating in accordance with a primary RAT over an operating channel and in accordance with a DTX communication pattern, the DTX communication pattern defining activated periods and deactivated periods of primary-RAT transmission over the operating channel 810 may correspond at least in some aspects to, for example, a communication device or a component thereof as discussed herein (e.g., the primary-RAT transceiver 140 or the like). A module for monitoring secondary-RAT signaling on a shared channel of the secondary RAT that at least partially overlaps in frequency space with the operating channel of the primary RAT 820 may correspond at least in some aspects to, for example, communication device or a component thereof as discussed herein (e.g., the secondary-RAT transceiver 142 or the like). A module for determining a channel type associated with the shared channel 830 may correspond at least in some aspects to, for example, a processor or a component thereof as discussed herein (e.g., the processing system 116 or the like). A module for setting one or more parameters of the DTX communication pattern based on the channel type associated with the shared channel 840 may correspond at least in some aspects to, for example, a processor or a component thereof as discussed herein (e.g., the processing system 116 or the like).

The functionality of the modules of FIG. 8 may be implemented in various ways consistent with the teachings herein. In some designs, the functionality of these modules may be implemented as one or more electrical components. In some designs, the functionality of these blocks may be implemented as a processing system including one or more processor components. In some designs, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIG. 8, as well as other components and functions described herein, may be implemented using any suitable means. Such means also may be implemented, at least in part, using corresponding structure as taught herein. For example, the components described above in conjunction with the “module for” components of FIG. 8 also may correspond to similarly designated “means for” functionality. Thus, in some aspects one or more of such means may be implemented using one or more of processor components, integrated circuits, or other suitable structure as taught herein.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

In view of the descriptions and explanations above, one skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in Random-Access Memory (RAM), flash memory, Read-only Memory (ROM), Erasable Programmable Read-only Memory (EPROM), Electrically Erasable Programmable Read-only Memory (EEPROM), registers, hard disk, a removable disk, a CD-ROM, or any other form of storage medium known in the art, transitory or non-transitory. An exemplary storage medium is coupled to the processor such that the processor can read information from, and write information to, the storage medium. In the alternative, the storage medium may be integral to the processor (e.g., cache memory).

Accordingly, it will also be appreciated, for example, that certain aspects of the disclosure can include a transitory or non-transitory computer-readable medium embodying a communication method. The method may comprise operating in accordance with a first RAT over an operating channel and in accordance with a DTX communication pattern, the DTX communication pattern defining activated periods and deactivated periods of primary-RAT transmission over the operating channel, monitoring secondary-RAT signaling on a shared channel of the secondary RAT that at least partially overlaps in frequency space with the operating channel of the primary RAT, determining a channel type associated with the shared channel, and setting one or more parameters of the DTX communication pattern based on the channel type associated with the shared channel.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A communication apparatus, comprising:
a first transceiver configured to operate in accordance with a primary Radio Access Technology (RAT) over an operating channel and in accordance with a Discontinuous Transmission (DTX) communication pattern, the DTX communication pattern defining activated periods and deactivated periods of primary-RAT transmission over the operating channel;
a second transceiver configured to operate in accordance with a secondary RAT and to monitor secondary-RAT signaling on a shared channel of the secondary RAT that at least partially overlaps in frequency space with the operating channel of the primary RAT;
at least one processor; and
at least one memory coupled to the at least one processor, the at least one processor and the at least one memory being configured to:
determine a channel type associated with the shared channel; and
set one or more parameters of the DTX communication pattern based on the channel type associated with the shared channel.

2. The communication apparatus of claim 1, the processor being further configured to:
set the one or more parameters to a first set of values in response to the channel type indicating that the shared channel is a primary channel of the secondary RAT; and
set the one or more parameters to a second set of values in response to the channel type indicating that the shared channel is a secondary channel of the secondary RAT, the second set of values being associated with a higher utilization of the operating channel by the first transceiver than the first set of values.

3. The communication apparatus of claim 1, the processor being further configured to:
determine a position of the shared channel within a channel structure of the secondary RAT in response to a determination that the shared channel is a secondary channel of the secondary RAT; and
set the one or more parameters based on the position of the shared channel.

4. The communication apparatus of claim 3, the processor being further configured to determine the position of the shared channel based on:
a proximity of the shared channel to a corresponding primary channel; and
a bandwidth associated with all of the channels associated with the primary channel.

5. The communication apparatus of claim 4, the processor being further configured to set the one or more parameters to:
a first set of values for a first position of the shared channel; and
a second set of values for a second position of the shared channel, the first position being closer to the primary channel than the second position, and the first set of values being associated with a lower utilization of the operating channel by the first transceiver than the second set of values.

6. The communication apparatus of claim 1, the processor being further configured to:
determine a medium utilization metric associated with utilization of the shared channel by the secondary-RAT signaling and to set a medium utilization threshold based at least in part on the channel type associated with the shared channel; and
set the one or more parameters based on a comparison of the medium utilization metric and the medium utilization threshold.

7. The communication apparatus of claim 6, the processor being further configured to set the medium utilization threshold to:
a first value in response to the channel type indicating that the shared channel is a primary channel of the secondary RAT; and
a second value in response to the channel type indicating that the shared channel is a secondary channel of the secondary RAT, the first value being associated with a lower utilization of the shared channel than the second value.

8. The communication apparatus of claim 7, the processor being further configured to set the one or more parameters to:
a first set of values in response to the medium utilization metric being above the medium utilization threshold; and
a second set of values in response to the medium utilization metric being below the medium utilization threshold, the first set of values being associated with a lower utilization of the operating channel by the first transceiver than the second set of values.

9. The communication apparatus of claim 6, the processor being further configured to:
set the medium utilization threshold based further on a position of the shared channel within a channel structure of the secondary RAT in response to the channel type indicating that the shared channel is a secondary channel of the secondary RAT; and
set the one or more parameters based on the position of the shared channel.

10. The communication apparatus of claim 1, the processor being further configured to:
identify a plurality of secondary-RAT networks operating on the shared channel and to determine a channel type associated with the shared channel for each of the plurality of secondary-RAT networks; and
set the one or more parameters based on each of the channel types associated with the shared channel.

11. The communication apparatus of claim 1, the one or more DTX parameters comprising a parameter related to a duty cycle of the activated periods of the DTX communication pattern, a parameter related to a periodicity of the DTX communication pattern, or a combination thereof.

12. The communication apparatus of claim 1, the primary RAT comprising Long Term Evolution (LTE) technology and the secondary RAT comprising WLAN technology.

13. A communication method, comprising:
operating in accordance with a primary Radio Access Technology (RAT) over an operating channel and in accordance with a Discontinuous Transmission (DTX) communication pattern, the DTX communication pattern defining activated periods and deactivated periods of primary-RAT transmission over the operating channel;
monitoring secondary-RAT signaling on a shared channel of the secondary RAT that at least partially overlaps in frequency space with the operating channel of the primary RAT;
determining a channel type associated with the shared channel; and
setting one or more parameters of the DTX communication pattern based on the channel type associated with the shared channel.

14. The communication method of claim 13, the setting of the one or more parameters comprising:
setting the one or more parameters to a first set of values in response to the channel type indicating that the shared channel is a primary channel of the secondary RAT; and
setting the one or more parameters to a second set of values in response to the channel type indicating that the shared channel is a secondary channel of the secondary RAT, the second set of values being associated with a higher utilization of the operating channel by the first transceiver than the first set of values.

15. The communication method of claim 13, further comprising:
determining a position of the shared channel within a channel structure of the secondary RAT in response to a determination that the shared channel is a secondary channel of the secondary RAT;
the setting of the one or more parameters comprising setting the one or more parameters based on the position of the shared channel.

16. The communication method of claim 15, the determining of the position of the shared channel being based on:
a proximity of the shared channel to a corresponding primary channel; and
a bandwidth associated with all of the channels associated with the primary channel.

17. The communication method of claim 16, the setting of the one or more parameters comprising:
setting the one or more parameters to a first set of values for a first position of the shared channel; and
setting the one or more parameters to a second set of values for a second position of the shared channel, the first position being closer to the primary channel than the second position, and the first set of values being associated with a lower utilization of the operating channel by the first transceiver than the second set of values.

18. The communication method of claim 13, further comprising:
determining a medium utilization metric associated with utilization of the shared channel by the secondary-RAT signaling;
setting a medium utilization threshold based at least in part on the channel type associated with the shared channel; and
setting the one or more parameters based on a comparison of the medium utilization metric and the medium utilization threshold.

19. The communication method of claim 18, the setting of the medium utilization threshold comprising:
setting the medium utilization threshold to a first value in response to the channel type indicating that the shared channel is a primary channel of the secondary RAT; and
setting the medium utilization threshold to a second value in response to the channel type indicating that the shared channel is a secondary channel of the secondary RAT, the first value being associated with a lower utilization of the shared channel than the second value.

20. A communication apparatus, comprising:
means for operating in accordance with a primary Radio Access Technology (RAT) over an operating channel and in accordance with a Discontinuous Transmission (DTX) communication pattern, the DTX communication pattern defining activated periods and deactivated periods of primary-RAT transmission over the operating channel;
means for monitoring secondary-RAT signaling on a shared channel of the secondary RAT that at least partially overlaps in frequency space with the operating channel of the primary RAT;
means for determining a channel type associated with the shared channel; and
means for setting one or more parameters of the DTX communication pattern based on the channel type associated with the shared channel.
